(19) United States
(12) Patent Application Publication
(10) Pub. No.: US 2015/0254689 A1
(43) Pub. Date: Sep. 10, 2015

(54) End of Life Product Planning

(71) Applicant: International Business Machines Corporation, Armonk, NY (US)

(72) Inventors: Yasuo Amemiya, Hartsdale, NY (US); Markus R. Ettl, Ossining, NY (US); Elijah Gaioni, Rockville Centre, NY (US); John M. Konopka, Tempe, AZ (US); John J. McAlpin, Cary, NC (US); Philip J. Poetzinger, Cary, NC (US); Anne M. Sweetland, Wappingers Falls, NY (US)

(73) Assignee: International Business Machines Corporation, Armonk, NY (US)

(21) Appl. No.: 14/513,876

(22) Filed: Oct. 14, 2014

Related U.S. Application Data
(63) Continuation of application No. 14/197,765, filed on Mar. 5, 2014.

(51) Int. Cl. G06Q 30/02; G06Q 10/08

(52) U.S. Cl. CPC G06Q 30/0202; G06Q 10/087

(57) ABSTRACT

Embodiments include a data based methodology for projecting cumulative shipments of a product throughout the balance of its life cycle. Critical milestones are defines, and are employed to break a product life cycle into manageable segments. A double base line curve is employed, with a first baseline curve representing shipment of a predecessor product prior to announcement of the new product and a second baseline curve representing shipment of the predecessor product after announcement of the new product. The curves are used as a reference point with a product analysis to statistically forecast an end of life demand for the predecessor product.

### CROSS REFERENCE TO RELATED APPLICATION(S)

This application is a continuation patent application claiming the benefit of the filing date of U.S. patent application Ser. No. 14/197,765 filed on Mar. 5, 2014 and titled “End of Life Product Planning” now pending, which is hereby incorporated by reference.

### BACKGROUND

### Technical Field

The present invention relates to constructing a model for end of product life. More specifically, the invention relates to utilization of the constructed model to forecast sales and/or demand at the end of product life.

Prevention of excess material at the end of a product's life cycle is critical to the overall financial integrity of a hardware product offering. Transitions from a predecessor product to a new product can result in significant excess material associated with the predecessor product if the transition to the new product offering is based on flexible revenue protection strategies that rely on committed supply for both the new product and the old product. While such a transition plan may maximize revenue by allowing sale flexibility in a mix of old and new products sold during such a transition, the typical result is significant excess old material remaining. In some circumstances this is due to an overwhelming desirability of new features associated with the replacement product. At the same time, profitability associated with the new product is negatively impacted by inventory scrapped at the end of product life as well as costs associated with attempts to dispose of the excess materials. Even the new product can be sub-optimized by the end of life phase of its predecessor by the redirection of resources moved off of the new product to drive efforts to sell excess of the predecessor product and minimize scrap material.

### SUMMARY OF THE INVENTION

This invention comprises a method for projecting cumulative shipments of a product throughout the balance of its lifecycle and to forecast additional shipments for the product of interest over its remaining life cycle.

A method is provided for employing an end of product life analytic to understand a transitional effect of a new product launch on a predecessor product. The analytic includes predicting a demand forecast for a final sales period for the predecessor product. A model is constructed to forecast a remaining lifecycle for the predecessor product. The model employs two baselines curves, including a first baseline curve and a second baseline curve. The first baseline curve represents shipment of the predecessor product prior to announcement of the new product. The second baseline curve represents shipment of the predecessor product after announcement of the new product. An end of life demand is statistically forecasted for the predecessor product. The forecast includes curves from the model functioning as a reference point.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a flow chart depicting a process for selection of one or more products to analyze.

FIG. 2 is a flow chart depicting a process for organizing data by quarterly shipment of a product over the life cycle.

FIG. 3 is a flow chart depicting analysis of generational product transitions.

FIG. 4 is a graph demonstrating generational product transitions.

FIG. 5 is a flow chart depicting cumulative product analysis.

FIG. 6 is a graph illustrating a representation of the cumulative product gathering demonstrated in FIG. 5.

FIG. 7 is a flow chart depicting a review of the cumulative product analysis.

FIG. 8 is a flow chart depicting a process for utilizing double baseline curves to forecast an end of life demand for a product.

FIG. 9 is a graph illustrating a product end of life forecast.

FIG. 10 is a block diagram depicting tools and components embedded in a computer system to support transitional, regression, and cumulative analysis within a product life cycle and across product generations.

FIG. 11 is a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, modules, and/or managers. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of managers, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

Sales of a product vary over the lifespan of the product. There are several milestones related to product sales. Examples of these milestones include announcement, general announcement, follow-on announcement, withdrawal announcement, and end of manufacturing. From the start of a product release at the product announcement, sales are initiated. A pattern associated with the sales across each of these milestones may be tracked. As a subsequent product is released, or otherwise subject to an announcement or a general announcement, sales of the preceding generation of the product are affected. It is inefficient, and often considered a waste, to have product inventory remaining after the end of manufacturing. Remaining products are either sold for minimal profit, and sometimes at a loss, or the parts are scrapped for the value of the raw material. Accordingly, there is a need to gather data, study the effects of milestones on a current product, to predict behavior of the next generation product.

A data based methodology is employed for projecting cumulative shipments of a product throughout the balance of its life cycle. This projection is compared to a proposed sales plan to mitigate excess inventory at the end of the life cycle. The product lifecycle is divided into multiple segments, each of the segments having a specific definition and/or characteristic. In one embodiment, each segment is handled in a different manner. Sales of the products can be tracked on different intervals, including a quarterly basis, seasonally, monthly, etc. Similarly, the effects of an announcement or release of a subsequent generation product can be tracked with respect to a current or prior product. Shipment of a new generation product affects shipment of a prior generation product. The affects have been known to cause a decrease in shipment of the prior generation product, thereby decreasing its value. In one embodiment, shipment of the prior generation may ceases, causing excess inventory of minimal value. Accordingly, there is a need to accurately and statistically estimate the effects of the new product on the prior generation product in order to mitigate availability of excess inventory.

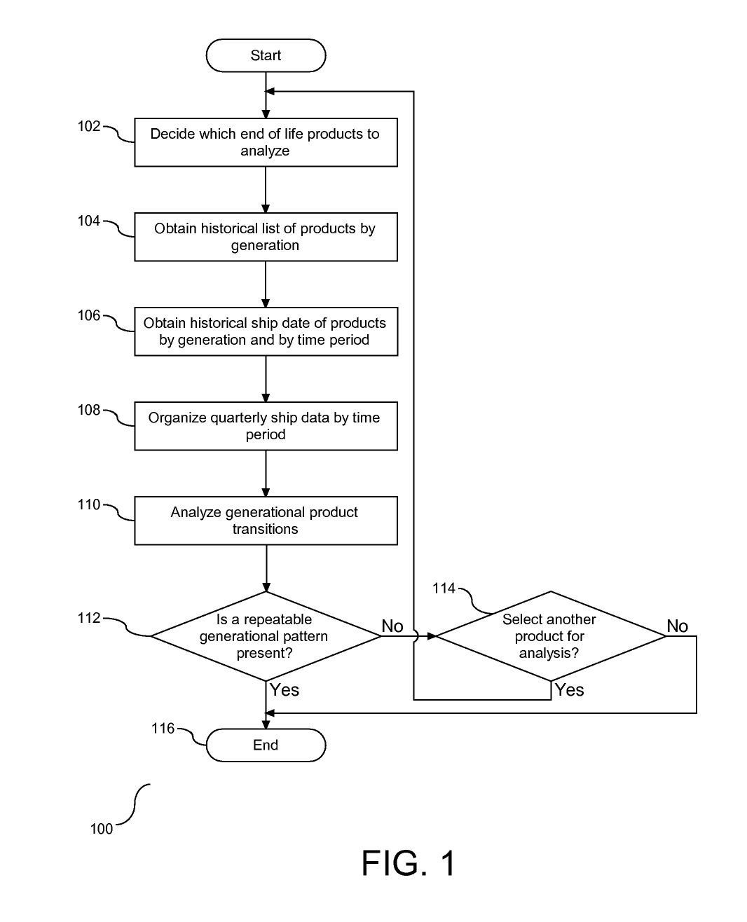

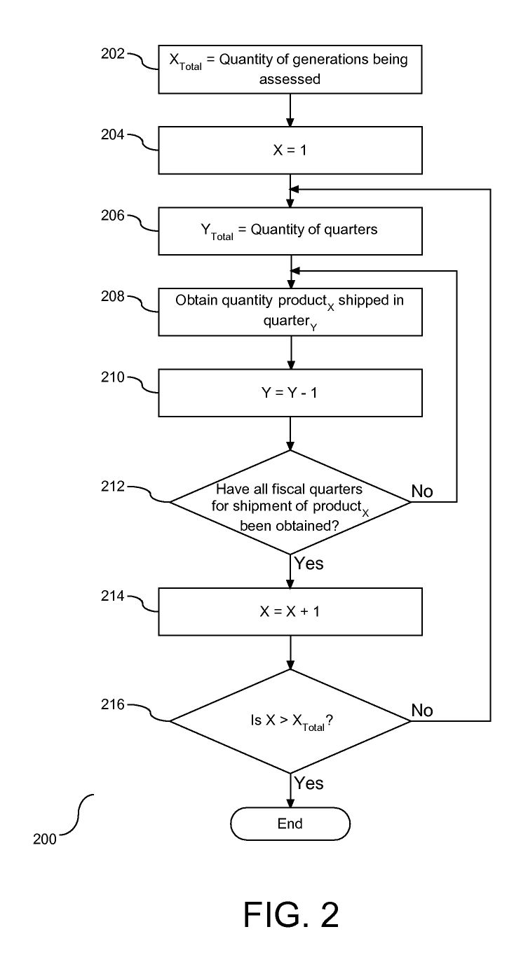

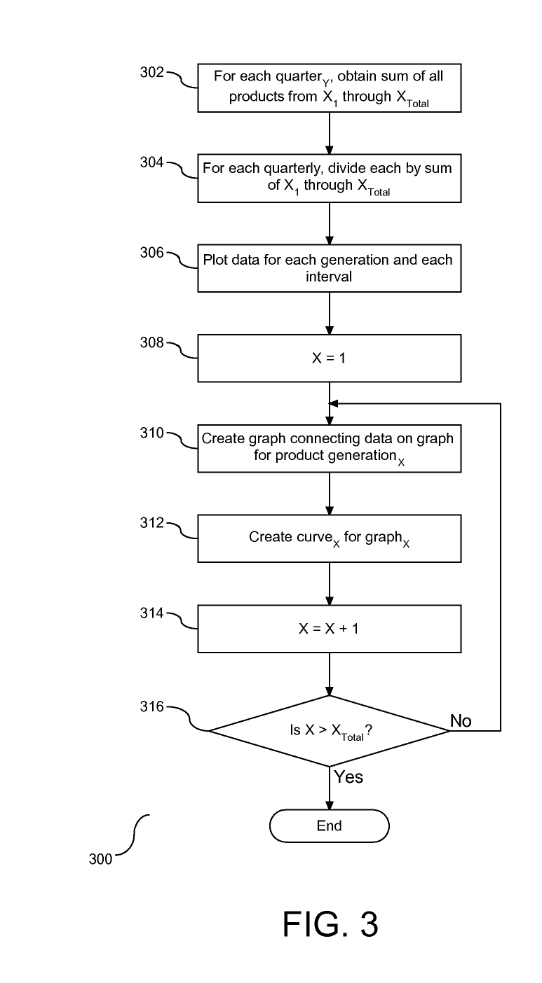

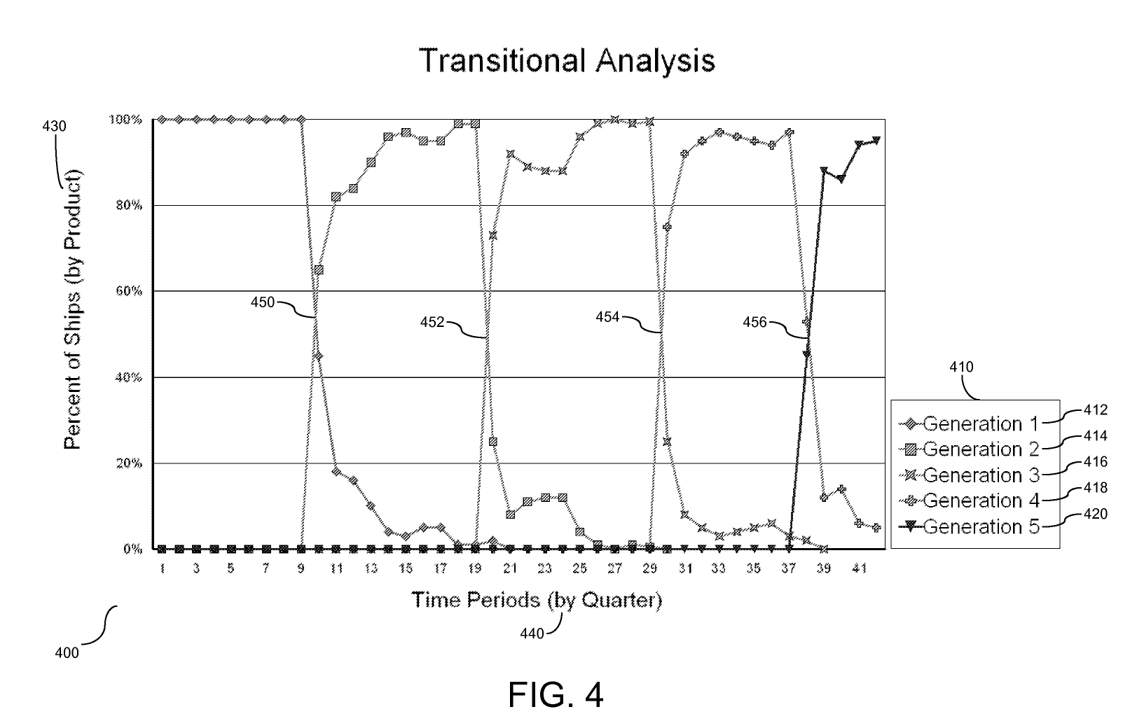

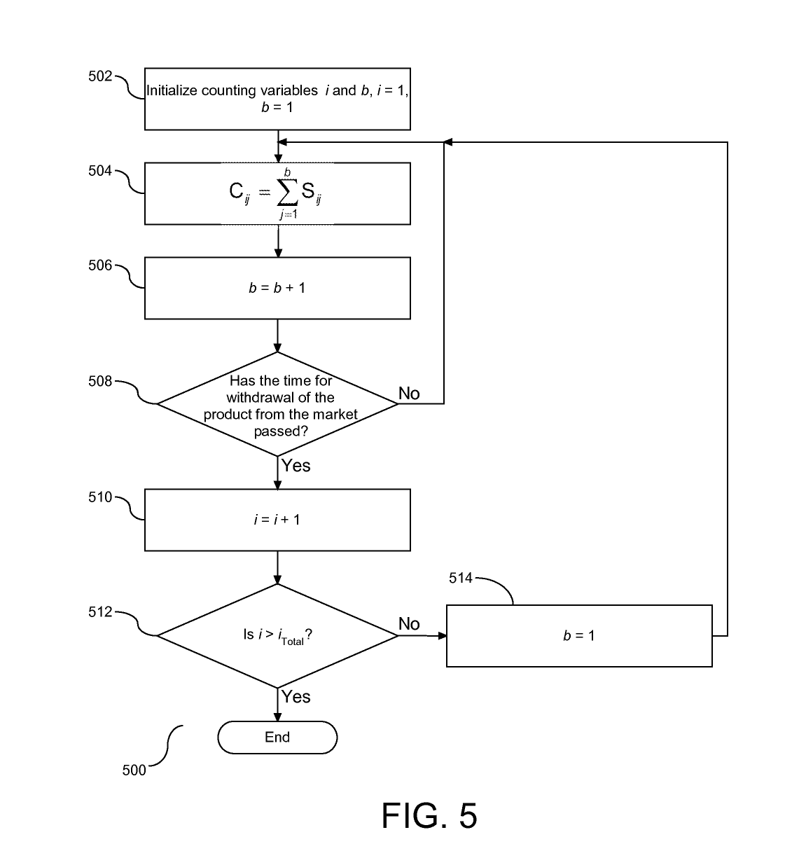

FIG. 1 is a flow chart (100) illustrating a process for selection of one or more products to analyze. As shown, the first part of the selection process entails deciding which end of life products to analyze (102). Following the decision at step (102), a historical list of products by generation is obtained (104), and historical ship data of products by generation and by time period is obtained (106). With the data gathered at steps (104) and (106), quarterly ship data is organized by time period (108). Details of the quarterly shipment data gathering is shown and described in detail in FIG. 2. Thereafter, generational products transitions are analyzed (110). Details of the analysis are described in detail in FIG. 3 and a graphical representation is shown in FIG. 4. Following the analysis at step (110) it is determined if there is a repeatable generational pattern present in the analysis (112). A negative response to the determination at step (112) is following by an inquiry to select another product for analysis (114). If there is another product to analyze, the process returns to step (102), otherwise the analysis is concluded (116). Conversely, if the response to the determination at step (112) shows there is a repeatable pattern present, a cumulative product analysis is conducted, as shown in FIG. 5. In one embodiment, even if a repeatable pattern is found at step (112), the process may proceed to step (114) for selection of another product for analysis before the cumulative product analysis is conducted.

Referring to FIG. 2, a flow chart (200) is shown demonstrating the process for organizing data by quarterly shipment of a product over the life cycle. In one embodiment, the products are generationally related, wherein a subsequent product includes additional features and functions than present in a prior generation of the product. As each product generation proceeds through the lifecycle, associated data is gathered and employed as historical data. The variable X_{Total} defines the quantity of generations of the product being assessed (202). An associated product generation counting variable, X, is initialized (204). Product sales may be assessed based on value and/or quantity of products shipped. The assessment may be based on a weekly, monthly, quarterly, or annual basis. In one embodiment, the product sales and/or shipments may be assessed on a seasonal basis. For descriptive purposes, the variable Y_{Total} defines the quantity of quarters over which the sales and/or shipments of the product have been collected, or in one embodiment, are in the process of being collected (206). For each product_{X}, the quantity of product shipped in quarter_{Y} is obtained (208). Accordingly, the first part of the baseline assessment is the collection of the data that will comprise the data set.

Following step (208), the counting variable for the current fiscal quarter, Y, is decreased (210). It is then determined if all of the fiscal quarters for shipment of product_{X} have been obtained (212). A negative response to the determination at step (212) is followed by a return to step (208). Conversely, a positive response to the determination at step (212) concludes the process of obtaining fiscal shipment data for product_{X}. As indicated above, the variable X is a counting variable for different generations of the product. Following step (212), the variable X is incremented (214), followed by an assessment to determine if fiscal shipment data has been obtained for all of the product generations (216). A negative response to the determination at step (216) is followed by a return to step (206), and a positive response to the determination at step (216) concludes the process of collecting the fiscal data. In one embodiment, the collection of fiscal data is obtained in real-time. Accordingly, data pertaining to quantity of product moved is gathered on a period basis across the lifespan of the product.

Once the data for the product generation(s) and the shipment or sales associated therewith has been gathered, generational product transitions are analyzed, as described in the flow chart (300) of FIG. 3. Specifically, ship data is converted to transitional data by generation. For each quarter_{Y}, the sum of all products from X₁ to X_{Total} in the quarter is obtained (302). In one embodiment, this is referred to as ΣS_{x,y}. In addition, for each quarter_{Y}, the products per quarter are divided by the sum of all products from X₁ to X_{Total} (304). In one embodiment, this is referred to as (S_{x,y}/ΣS_{x,y}). The computation at step (304) converts the products per quarter into a ratio. Thereafter, data for each generation and each interval is plotted (306). Following step (306), the quarter variable X is initialized (308), and a graph is created connecting data on the graph for product generation_{X} (310). Once the graph is completed, a curve representing the graph for product generation_{X} is created (312). Thereafter the counting variable X is incremented (314), and it is determined if a graph and associated curve have been created for all of the product generations (316). A negative response to the determination at step (316) is followed by a return to step (310), and a positive response concludes the creation and presentation of the product generation curves.

Referring to FIG. 4, a graph (400) is presented demonstrating generational product transitions. As shown in the legend (410), there are five generations illustrated in the graph, including (412), (414), (416), (418), and (420). A vertical axis (430) of the graph represents percentage of shipments by product, and a horizontal axis (440) of the graph represents time periods on a quarterly basis. As shown, there is a point on the graph between each product transition where the product shipment for the prior generation sharply decreases as the next product generation sharply increases. Specifically, at (450) a first transition point is identified between the first generation product (412) and the second generation product (414). At (452) a second transition point is identified between the second generation product (414) and the third generation product (416), at (454) a third transition point is identified between the third generation product (416) and the fourth generation product (418). At (456) a fourth transition point is identified between the fourth generation product (418) and the fifth generation product (420).

The generational product transitions represented in FIG. 4 graphically presents the quantity of products shipped or sold at a set interval through the course of the lifespan of the product. In one embodiment the quarterly interval may be replaced with finer granularity, such as monthly or weekly. The representation enables comparison of sales of one product to another product. Since the products are generationally related, a reduction in sales of one product may attribute to an increase in sales of another product. All of this is graphically visible and discernible from the generational representation.

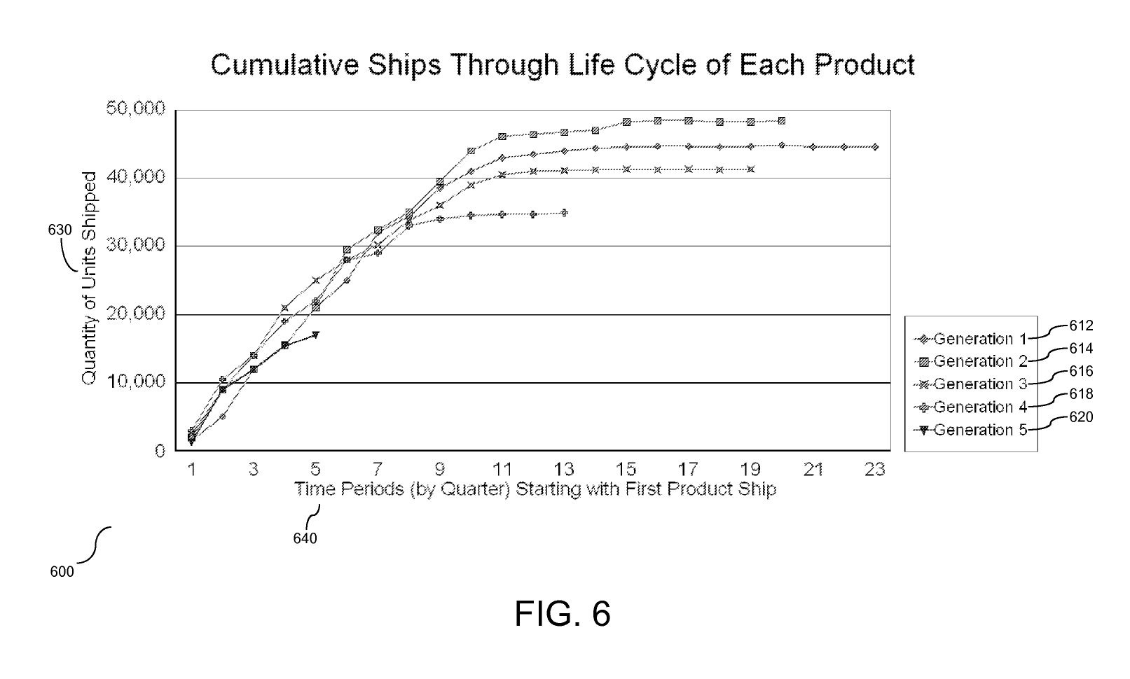

Referring to FIG. 5, a flow chart (500) is provided illustrating cumulative product analysis, and more specifically a process to analyze and arrange period and cumulative ship data by period. A counting variable, i, refers to the product, and a counting variable, b, refers to the time period. The counting variables i and b are initialized (502). As shown, period and cumulative ship data by period are analyzed and arranged. Specifically, cumulative totals, C_{i,j} are created by time period, b (504), wherein the cumulative total are the summation up to that moment in time for ship of product in periodⱼ. Following step (504), the counting variable b for the time period is incremented (506). It is then determined if the time for withdrawal of the product from market has passed (508). A negative response to the determination at step (508) is followed by a return to step (504). However, if the product has been withdrawn from the market, the counting variable for the product, i, is incremented (510). Following the increment at step (510) it is determined if all of the products subject to creation of the cumulative totals have been evaluated (512). A negative response to the determination at step (512) is followed by initialization of the time period variable, b (514), and a return to step (504). A positive response to the determination at step (512) is following by creating a cumulative graph and associated analysis, as shown and described in FIG. 6. For each product and each generation of each product, cumulative totals are created by time period from the first time period until the time period in which the product is withdrawn from the market. The cumulative ship data process continues for each product being analyzed. The focus of the cumulative ship data is to employ this data for long term sourcing and strategy decisions.

FIG. 6 is a graph (600) illustrating a representation of the cumulative product gathering demonstrated in FIG. 5. As shown in the legend (610), there are five generations illustrated in the graph, including (612), (614), (616), (618), and (620). A vertical axis (630) of the graph represents cumulative ship quantity and a horizontal axis (640) of the graph represents time periods on a quarterly basis starting with the first quarter product shipment. Accordingly, cumulative shipments through the life cycle of each product are shown herein.

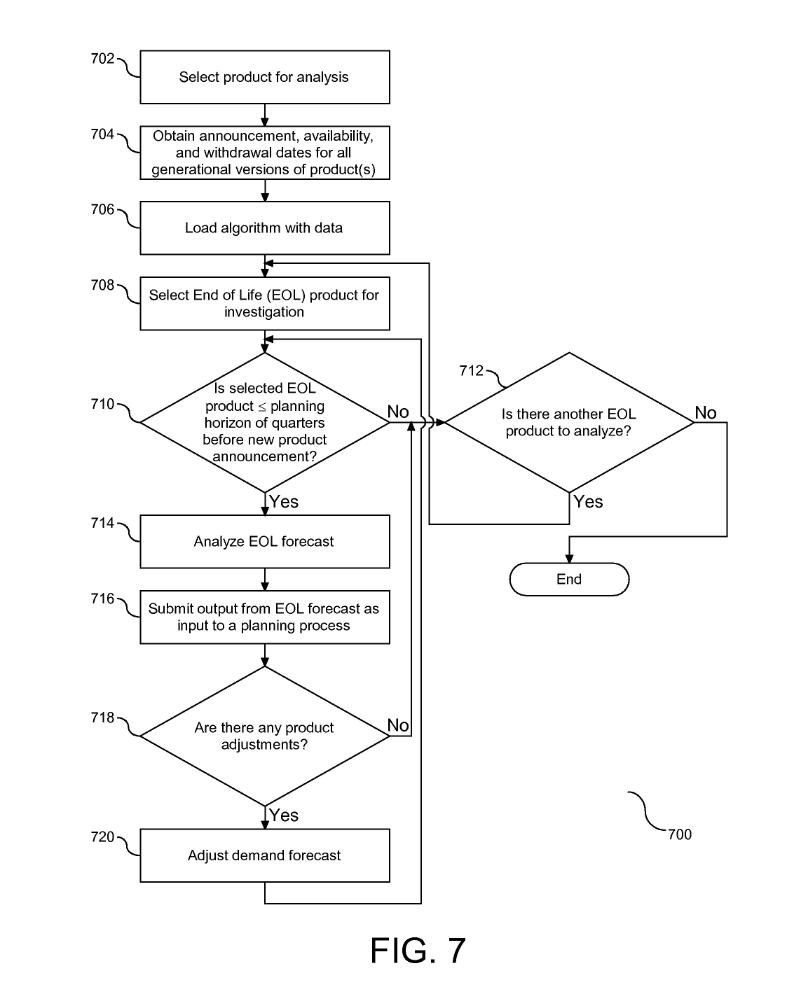

Following the gathering of cumulative product shipment data, as shown in FIG. 7, a flow chart (700) is provided showing a review of the cumulative product analysis. A product for analysis is selected (702), and announcement, availability and withdrawal dates for all generational versions for the selected product are obtained (704). A model referred to as a load algorithm is then loaded with the shipment data, product announcement, product availability, and product withdrawal data, together with generational relationship data (706). After the data has been loaded, an end of life (EOL) product is selected for investigation (708). Following the selection at step (708), it is determined if the EOL product selected at step (708) is less than or equal to a planning horizon of quarters before a new product announcement (710). A negative response to the determination at step (710) is followed by determining if there is another EOL product to analyze (712). A positive response to the determination at step (712) is followed by a return to step (708), and a negative response to the determination at step (712) concludes the product analysis.

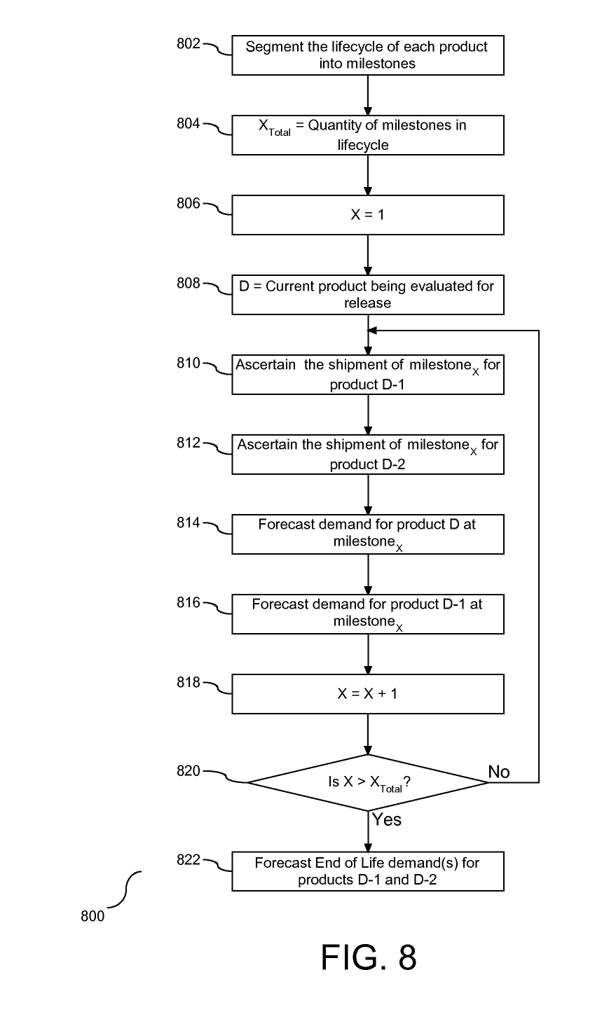

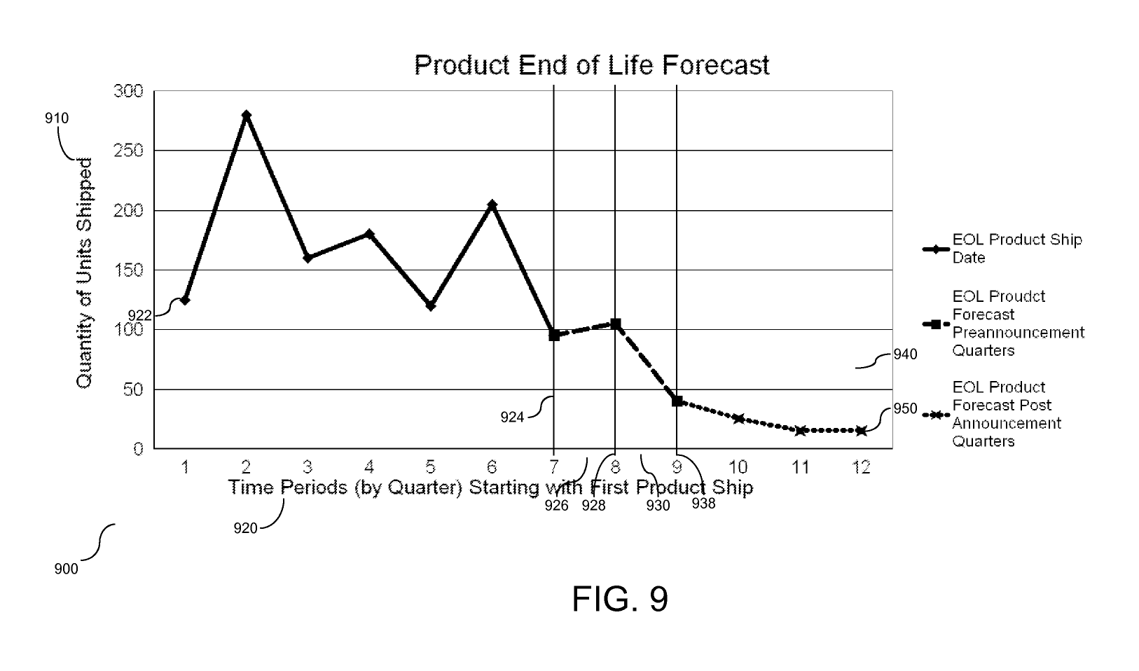

If the response to the determination at step (710) is positive, the process proceeds to FIG. 8 for analysis of the EOL forecast (714), the analysis including predicting a demand forecast for each remaining sales period for the predecessor product, including a product decline phase through product withdrawal. In one embodiment, output of the EOL forecast may be quarterly and may proceed through product withdrawal. Output from the EOL forecast is submitted as input to a planning process (716), as demonstrated in FIG. 9. It is then determined if there are any product adjustments (718). A positive response to the determination at step (718) is followed by adjusting the demand forecast (720). Adjustments may include, but are not limited to changes to announcement, withdrawal and availability dates (720), followed by a return to step (710). A negative response is followed by a return to step (712) to determine if there is another EOL product to analyze. Accordingly, as shown herein data is loaded for products that can be analyzed, and analysis time and threshold are reviewed to provide a cumulative forecast that can be used for long term sourcing and strategy decisions.

Referring to FIG. 8, a flow chart (800) is provided illustrating a process for utilizing double baseline curves to forecast an end of life demand for a product. As products evolve and a new generation product is created. It is understood that the new generation product may contain improvements to the prior generation. If two or more generations of the product overlap with respect to availability, this may affect sales of each generation. For example, the purchase price of an older generation product may be reduced and entice consumers based on a lower cost. At the same time, some consumers may prefer the new generation product based on the new functionality, whether or not the prior generation product is cost effective. A variety of factors control the purchase of generationally related products. It is recognized that sales of a product may be affected by critical milestones, including but not limited to announcement, general availability, follow-on announcement, follow-on general availability, withdrawal announcement, and end of product manufacturing. The use of these milestones breaks a product life cycle into manageable segments and allows each segment to be handled differently.

To utilize the baseline curves, the lifecycle of each of the products represented is segmented into milestones (802). The variable X_{Total} represents the quantity of milestones in the lifecycle (804), and an associated counting variable X is initialized (806). As described above, the first milestone of a product is the announcement of the product. The variable D represents the current product being evaluated for release (808). In one embodiment, the current product, D, is not represented on the graphs, e.g. the current product has not been announced. Similarly, in one embodiment, the graphs are being utilized to assess an optimal time for announcement of product D. The graphs are consulted to ascertain the shipment at milestone X of product D−1 (810). At the same time, it is important to determine the effect of release of the prior generation product on the earlier generation. In other words, when the prior product announcement took place, how did this affect the sales of the earlier generation product. Following step (810), the graphs are consulted to ascertain the shipment at milestone X of product D−2 (812). The data gathered at steps (810) and (812) demonstrate how release of one product affected sales of a prior product. The historical patterns are evaluated to estimate future behavior. Specifically, a demand for product D is forecasted at milestone X (814). In addition, a demand for product D−1 is also forecasted at milestone X (816). The two forecasts provide insight into the effect of sales of two adjacent generations of products at corresponding milestones.

Following step (816), the next milestone is set by an increment of the milestone counting variable (818). It is then determined if each of the forecasting has been completed for each of the product generations at each milestone (820). A negative response to the determination at step (820) is followed by a return to step (810), and a positive response is followed by forecasting the end of life demand for products D−1 and D−2 (822). In one embodiment, the forecasting may be limited to the prior generation, or may be expanded to multiple product generations. Accordingly, for each generation, the sales and/or product shipments are assessed based on the milestones associated with the lifecycle of the product.

Forecasting the end of life of a product addresses the aspect of transitioning between generations of the product. As the product nears the end of its life, the goal is to minimize product remaining in inventory, as well as scrap material that is employed to manufacture the product. This data may be used to predict the end of life of a current product as the next generation of the product is announced or released. Similarly, this data may be used to predict the end of life of the product being released with respect to the next generation. This prediction enables more accurate inventory planning over the course of the product life and reduces excess inventory exposures during product transitions.

Referring to FIG. 9, a graph (900) illustrating a graphical representation of the demand forecast. In one embodiment, the forecast may be considered a prediction. As shown, the vertical axis (910) represents shipment quantity, and the horizontal axis (920) represents time shown in a quarterly representation. Data from the first quarter (922) through the seventh quarter (924) represents actual shipment of product. Starting at the beginning of the seventh quarter (924), the actual ship data of the product has ended and the EOL forecast begins. As shown, the period (926) from the seventh quarter (924) to the eighth quarter (928) is the beginning of the forecasting. The period (930) from the eighth quarter (928) to the ninth quarter (938) is the pre-announcement period for the next product. Starting with the ninth quarter (938), the announcement of the next product has started, and following the ninth quarter (940) the next generation product is starting to be shipped. Data from the ninth quarter (938) through the twelfth quarter (950) represents the EOL product forecast. Accordingly, the graph provides a visual representation of remaining quantity of product shipment through the final four quarters.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer or mobile device (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

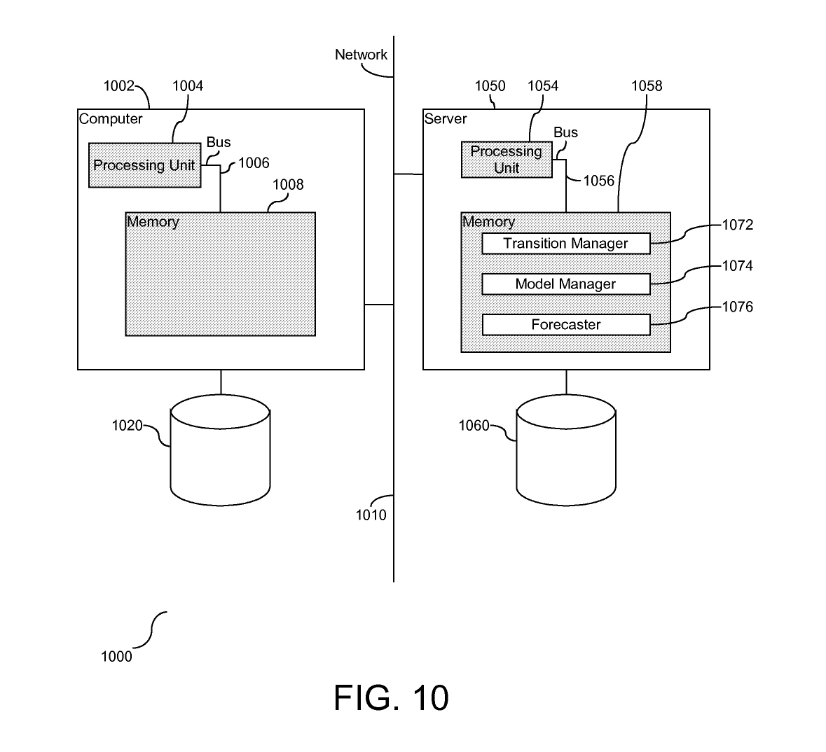

The process and graphs shown in FIGS. 1-9 provide advantages for introduction of a new product that aids in the mitigation of inventory of a predecessor product. One advantage is that by profiling the life cycle of the prior product, sales of the product at the end of the life cycle may be predicted and used to minimize remaining inventory. The processes shown herein may be embodied as hardware components. FIG. 10 is a block diagram (1000) illustrating tools and components embedded in a computer system to support transitional, regression, and cumulative analysis within a product life cycle and across product generations. A computer or related computing device (1002) is provided in communication with data storage (1020). The device (1002) includes a processing unit (1004) in communication with memory (1008) across a bus (1006). The device (1002) is in communication with a server (1050) across a network (1010). While only one server (1050) and device (1002) are depicted, any number of servers and computing devices may be implemented. The server (1050) includes a processing unit (1054) in communication with memory (1058) across a bus (1056). At the same time, the server (1050) is in communication with data storage (1060). In one embodiment, the data storage (1060) is a pool of shared storage device, also referred to herein as a cloud based resource.

One or more tools are provided in the system to support functionality associated with a statistical forecasting tool, as described in FIGS. 1-9. The tools include, but are not limited to, a transition manager (1072), a model manager (1074), and a forecaster (1076). Together, the tools (1072)-(1076) function to forecast the life cycle of a product, and therefore facilitate transition from a predecessor product while mitigating remaining inventory.

The server (1050) is provided with data storage (1060), which in one embodiment stores the historical and current data utilized for lifecycle forecasting. In one embodiment, some or all of the data is stored on a remote data center (not shown) in communication with the server (1050) across the network connection (1010). The server (1050) provides a venue for forecasting the end of product life and supports granularity of product lifecycle modeling. As noted above, the transition manager (1072) functions in communication with the processing unit (1004). More specifically, the transition manager (1072) employs an end of product life analytic to understand a transitional effect of a new product launch on a predecessor product. The transition manager (1072) predicts a demand forecast for a final sales period for the predecessor product. The model manager (1074) communicates with the transition manager (1072) and functions to construct a model that can be used to forecast a remaining lifecycle for the predecessor product. In one embodiment, the model is in the form of a double baseline, with a first baseline curve representing shipment of the predecessor product prior to announcement of the new product, and with the second baseline curve representing shipment of the predecessor product after announcement of the new product. The forecast includes curves from the model functioning as a reference point. A sample double baseline representation is shown in FIG. 4. The curves represented in FIG. 4 are based upon historical data of preceding products. In one embodiment, the curves are rescaled to reflect recent data, e.g. recent product shipment or sales data.

The transition manager (1072) facilitates transition between successively launched products, and the model manager (1074) functions to graphically illustrate the behavior of the sales or shipments of the product over time. In addition, a forecaster (1076) is provided in communication with the model manager (1074) and utilizes the curves and the statistics represented in the curves to forecast an end of life demand for the predecessor product. The curves represented in the double baseline function as a reference point input to the forecast. The statistical forecasting validates accuracy with historical data from the predecessor product. In one embodiment, the announcement of release or impending release of a product may affect the remaining sales of the preceding product. The forecaster (1076) functions to predict a demand forecast to mitigate remaining inventory for the predecessor product, e.g. final sales period. Specifically, the forecaster predicts how the sales or shipment of the product will decline through product withdrawal. In one embodiment, the forecaster (1076) may adjust or recommend adjustment of the announcement data of the new product and/or an availability date of the new product. For example, the adjustment may be in response to slower than expected sales or shipment of the current product, or a projected forecast of an increased inventory.

As articulated above, historical data is employed to forecast the end of life of a current product in anticipation of announcement and release of the next generation of the product. The tools shown herein employ the processing unit(s) to support their computations for product life projections. As identified above, the tools (1072)-(1076) are shown residing in memory (1058) of the server (1050). In one embodiment, the tools (1072)-(1076) may be implemented as a combination of hardware and software in a shared pool of resources. Similarly, in one embodiment, the tools (1072)-(1076) may be combined into a single functional item that incorporates the functionality of the separate items. As shown herein, each of the tools (1072)-(1076) are shown local to the server (1050). However, in one embodiment, they may be collectively or individually distributed across a shared pool of configurable computer resources and function as a unit to support sub-system attribute modification. Accordingly, the tools may be implemented as software tools, hardware tools, or a combination of software and hardware tools.

The described features, structures, or characteristics may be combined in any suitable manner in one or more embodiments. Examples of the managers have been provided to lend a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The tools shown and described in FIG. 10 may be implemented in programmable hardware devices such as field programmable gate arrays, programmable array logic, programmable logic devices, or the like. The tool(s) may also be implemented in software for processing by various types of processors. An identified tool of executable code may, for instance, comprise one or more physical or logical blocks of computer instructions which may, for instance, be organized as an object, procedure, function, or other construct. Nevertheless, the executable of an identified tool need not be physically located together, but may comprise disparate instructions stored in different locations which, when joined logically together, comprise the tools and achieve the stated purpose of the tools.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

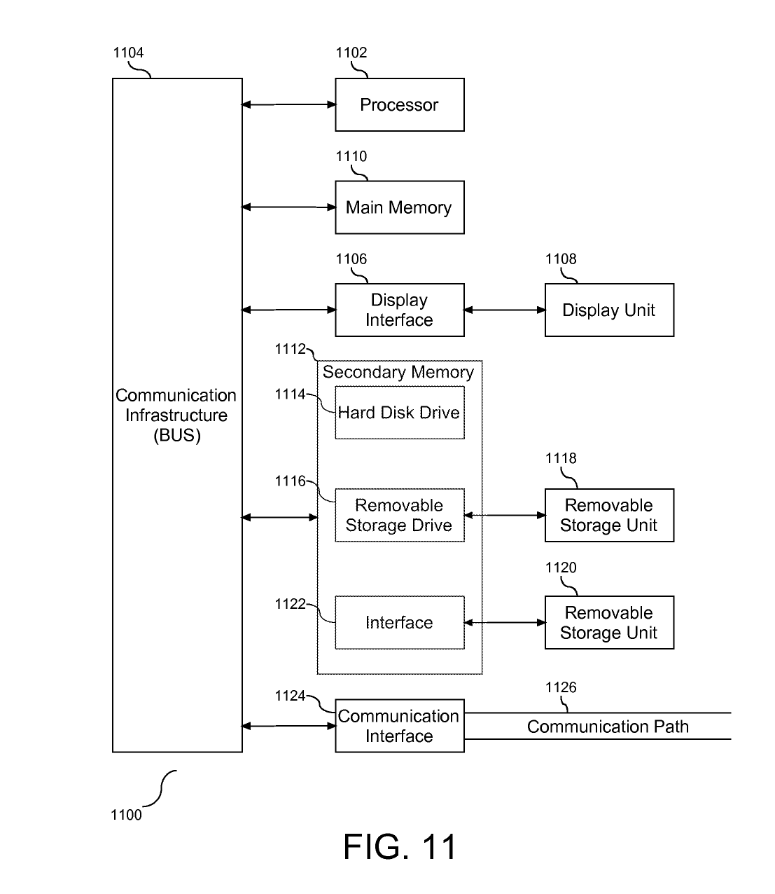

Referring now to the block diagram (1100) of FIG. 11, additional details are now described with respect to implementing an embodiment of the present invention. The computer system includes one or more processors, such as a processor (1102). The processor (1102) is connected to a communication infrastructure (1104) (e.g., a communications bus, cross-over bar, or network).

The computer system can include a display interface (1106) that forwards graphics, text, and other data from the communication infrastructure (1104) (or from a frame buffer not shown) for display on a display unit (1108). The computer system also includes a main memory (1110), preferably random access memory (RAM), and may also include a secondary memory (1112). The secondary memory (1112) may include, for example, a hard disk drive (1114) (or alternative persistent storage device) and/or a removable storage drive (1116), representing, for example, a floppy disk drive, a magnetic tape drive, or an optical disk drive. The removable storage drive (1116) reads from and/or writes to a removable storage unit (1118) in a manner well known to those having ordinary skill in the art. Removable storage unit (1118) represents, for example, a floppy disk, a compact disc, a magnetic tape, or an optical disk, etc., which is read by and written to by a removable storage drive (1116). As will be appreciated, the removable storage unit (1118) includes a computer readable medium having stored therein computer software and/or data.

In alternative embodiments, the secondary memory (1112) may include other similar means for allowing computer programs or other instructions to be loaded into the computer system. Such means may include, for example, a removable storage unit (1120) and an interface (1122). Examples of such means may include a program package and package interface (such as that found in video game devices), a removable memory chip (such as an EPROM, or PROM) and associated socket, and other removable storage units (1120) and interfaces (1122) which allow software and data to be transferred from the removable storage unit (1120) to the computer system.

The computer system may also include a communications interface (1124). Communications interface (1124) allows software and data to be transferred between the computer system and external devices. Examples of communications interface (1124) may include a modem, a network interface (such as an Ethernet card), a communications port, or a PCMCIA slot and card, etc. Software and data transferred via communications interface (1124) are in the form of signals which may be, for example, electronic, electromagnetic, optical, or other signals capable of being received by communications interface (1124). These signals are provided to communications interface (1124) via a communications path (i.e., channel) (1126). This communications path (1126) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (1110) and secondary memory (1112), removable storage drive (1116), and a hard disk installed in hard disk drive or alternative persistent storage device (1114).

Computer programs (also called computer control logic) are stored in main memory (1110) and/or secondary memory (1112). Computer programs may also be received via a communication interface (1124). Such computer programs, when run, enable the computer system to perform the features of the present invention as discussed herein. In particular, the computer programs, when run, enable the processor (1102) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

We claim:

1. A method comprising:
employing an end of product life analytic to understand a transitional effect of a new product launch on a predecessor product, including predicting a demand forecast for a final sales period for the predecessor product;
constructing a model to forecast a remaining lifecycle for the predecessor product, the model including a first baseline curve representing shipment of the predecessor product prior to announcement of the new product and a second baseline curve representing shipment of the predecessor product after announcement of the new product; and
statistically forecasting an end of life demand for the predecessor product, including the first and second curves functioning as a reference point input to the forecast.

2. The method of claim 1, wherein the statistical forecasting validates accuracy with historical data from the predecessor product.

3. The method of claim 1, further comprising rescaling the baseline curves to reflect recent data.

4. The method of claim 1, further comprising seasonally adjusting actual shipment volumes within the first and second baseline curves.

5. The method of claim 1, further comprising predicting a demand forecast for each remaining sales period for the predecessor product, including a product decline phase through product withdrawal.

6. The method of claim 5, further comprising adjusting the demand forecast by changing an announcement date and an availability date of the new product.
